(19) United States
(12) Patent Application Publication
(10) Pub. No.: US 2023/0100767 A1
(43) Pub. Date: Mar. 30, 2023

(54) INFORMATION PROCESSING DEVICE, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Eiji MIYAMAE, Kanagawa (JP)

(73) Assignee: FUJIFILM Business Innovation Corp., Tokyo (JP)

(21) Appl. No.: 17/702,767

(22) Filed: Mar. 23, 2022

(30) Foreign Application Priority Data
Sep. 24, 2021 (JP) 2021-156014

(51) Int. Cl. H04L 65/403; H04M 3/56; H04L 65/1089; H04R 5/02; H04S 3/00; G10L 21/034; G10L 21/0364; G10L 25/57

(52) U.S. Cl. CPC H04L 65/403; H04M 3/568; H04L 65/1089; H04R 5/02; H04S 3/008; G10L 21/034; G10L 21/0364; G10L 25/57; H04M 2201/405; H04S 2400/01

(57) ABSTRACT

An information processing device includes a processor configured to output, in a case where a service is being used in which at least speech is exchanged among multiple users such that a conversation takes places among all of the multiple users, a speech of a separate conversation distinctly from a speech of the conversation taking place among all of the multiple users to a device of a user who is engaged in the separate conversation with a specific user from among the multiple users, and output the speech of the conversation taking place among all of the multiple users without outputting the speech of the separate conversation to a device of a user who is not engaged in the separate conversation.

### CROSS-REFERENCE TO RELATED APPLICATIONS

This application is based on and claims priority under 35 USC 119 from Japanese Patent Application No. 2021-156014 filed Sep. 24, 2021.

### BACKGROUND

### (i) Technical Field

The present disclosure relates to an information processing device, an information processing method, and a non-transitory computer readable medium.

### (ii) Related Art

In a service such as an online conferencing system in which at least speech is exchanged among multiple users, a separate conversation may take place between specific users among the multiple users in some cases.

Japanese Unexamined Patent Application Publication No. 6-164741 describes a system that divides multiple participants into multiple groups in advance, and achieves communication within the groups and communication for the conference as a whole.

Japanese Unexamined Patent Application Publication No. 2015-046822 describes a device that enhances and reproduces the voice of a specific participant.

### SUMMARY

In some cases, it may be desirable to have a separate conversation take place between specific users, without causing the specific users to stop participating in a conversation taking place among all of the multiple users.

Aspects of non-limiting embodiments of the present disclosure relate to a service in which at least speech is exchanged among multiple users such that a conversation takes place among all of the multiple users, and provides a mechanism that makes it possible for a separate conversation to take place between specific users without causing the specific users to stop participating in the conversation taking place among all of the multiple users.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to output, in a case where a service is being used in which at least speech is exchanged among multiple users such that a conversation takes places among all of the multiple users, a speech of a separate conversation distinctly from a speech of the conversation taking place among all of the multiple users to a device of a user who is engaged in the separate conversation with a specific user from among the multiple users, and output the speech of the conversation taking place among all of the multiple users without outputting the speech of the separate conversation to a device of a user who is not engaged in the separate conversation.

### BRIEF DESCRIPTION OF THE DRAWINGS

An exemplary embodiment of the present disclosure will be described in detail based on the following figures, wherein:

FIG. 1 is a block diagram illustrating a configuration of an information processing system;

FIG. 2 is a block diagram illustrating a hardware configuration of an online conferencing system;

FIG. 3 is a block diagram illustrating a hardware configuration of a terminal device;

FIG. 4 is a block diagram illustrating functions of the online conferencing system;

FIG. 5 is a flowchart illustrating a flow of processes by a separate conversation unit;

FIG. 6 is a flowchart illustrating a flow of processes by a communication control unit;

FIG. 7 is a flowchart illustrating a flow of processes by a speech control function of the communication control unit;

FIG. 8 is a flowchart illustrating a flow of processes by a microphone control function of the communication control unit;

FIG. 9 is a flowchart illustrating a flow of processes by an image processing function of the communication control unit;

FIG. 10 is a diagram that schematically illustrates the mouth areas of the faces of separate talkers;

FIG. 11 is a table illustrating a list of conference participants;

FIG. 12 is a diagram illustrating a screen displayed while an online conferencing service is in use;

FIG. 13 is a diagram illustrating a screen displayed while an online conferencing service is in use;

FIG. 14 is a table illustrating a list of conference participants;

FIG. 15 is a diagram illustrating a screen displayed while an online conferencing service is in use; and

FIG. 16 is a diagram illustrating a screen displayed while an online conferencing service is in use.

### DETAILED DESCRIPTION

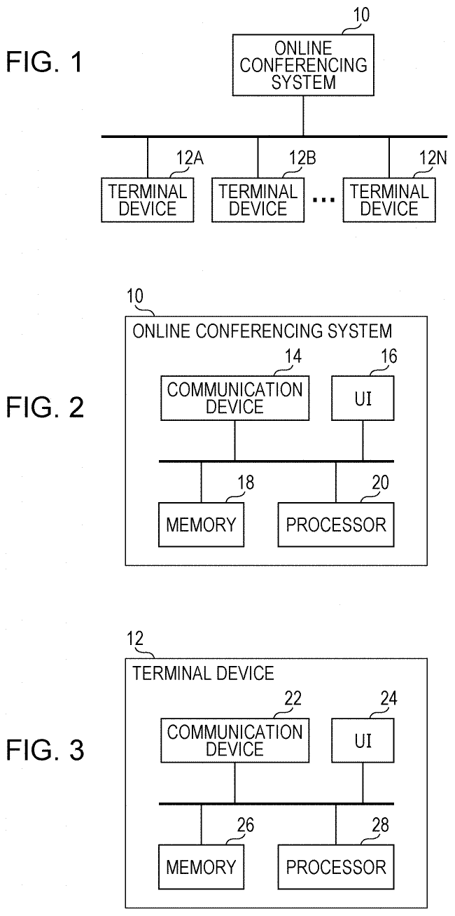

An information processing system according to an exemplary embodiment will be described with reference to FIG. 1. FIG. 1 illustrates an example of the configuration of the information processing system according to the exemplary embodiment.

The information processing system according to the exemplary embodiment includes an online conferencing system 10 and N terminal devices (where N is an integer equal to or greater than 1), for example. In the example illustrated in FIG. 1, the information processing system includes terminal devices 12A, 12B, . . . , 12N. Hereinafter, the terminal devices 12A, 12B, . . . , 12N will be referred to as the “terminal device(s) 12” when not being individually distinguished.

The online conferencing system 10 and the terminal devices 12 have a function of communicating with other devices. The communication may be wired communication using a cable, or wireless communication. The wireless communication is a technology such as short-range wireless communication or Wi-Fi (registered trademark). The short-range wireless communication is a technology such as Bluetooth (registered trademark) or radio-frequency identifier (RFID), for example. Each device may also communicate with another device through a communication channel such as a local area network (LAN) or the Internet.

The online conferencing system 10 provides a service allowing the exchange of information among multiple users.

The information exchanged in the service is, for example, images, video, audio, text, signs and symbols other than text, files, or a combination of at least two of the above. Obviously, information other than the above may also be exchanged. Exchanging information refers to transmitting information and receiving information.

The service is a service provided by an online conference, for example. In the online conference, information such as speech, images, and video for example is exchanged among multiple users. An online conference is also referred to as a web conference, a remote conference, or a video conference. The service may also be a service that provides a social networking service (SNS). In the following, the service provided by the online conferencing system 10 will be referred to as the “online conferencing service”. Although the term “conference” is included in the name of the service out of convenience, the service may also be used for purposes other than a conference. In such cases, information such as speech, images, and video for example is likewise exchanged among multiple users.

Each terminal device 12 is a device such as a personal computer (hereinafter referred to as a “PC”), a tablet PC, a smartphone, or a mobile phone, for example.

A user uses the terminal device 12 to access the online conferencing system 10 and use the online conferencing service provided by the online conferencing system 10. For example, by having multiple users use their own respective terminal devices 12 to use the online conferencing service, information is exchanged among the multiple users.

In the online conferencing service, information is exchanged among multiple terminal devices 12, for example. A user account for using the online conferencing service may be created for each user, and information may be exchanged among multiple user accounts.

For example, an address (for example, a URL) for accessing and using the online conferencing service is generated by the online conferencing system 10. Each user acquires and accesses the address using his or her own terminal device 12, thereby enabling the user to use the online conferencing service corresponding to the address.

For example, if a user who acts as the host of an online conference uses his or her own terminal device 12 to request the online conferencing system 10 for use of the online conferencing service, an address for accessing the online conferencing service is generated by the online conferencing system 10. As a response to the request from the user, the address is transmitted from the online conferencing system 10 to the terminal device 12. It is assumed that the user acquiring the address will transmit the address to other users who will participate in the same online conferencing service. With this arrangement, each user is able to acquire the address to access and participate in the same online conferencing service.

Channels may also be created for the online conferencing service, and information may be exchanged among multiple users in each channel. For example, the online conferencing system 10 generates, for each channel, an address for accessing and using the online conferencing service corresponding to the channel. By accessing one of the addresses using the terminal device 12, a user is able to use the online conferencing service in the channel corresponding to the accessed address.

A service ID and a corresponding password for using the online conferencing service may also be generated by the online conferencing system 10, and the online conferencing service corresponding to the service ID and the password may be provided to users. A user acquires the service ID and corresponding password, uses the terminal device 12 to access the online conferencing system 10, and transmits the service ID and the password to the online conferencing system 10. With this arrangement, the online conferencing service corresponding to the service ID and the password is provided to the user.

A channel service ID and a corresponding password may also be generated for each channel by the online conferencing system 10, and the online conferencing service in the channel corresponding to the service ID and the password may be provided to users.

In the online conferencing service according to the exemplary embodiment, at least speech is exchanged among the multiple users participating in the same online conferencing service, and a conversation takes place among all of the multiple users. Additionally, a separate conversation also takes place between specific users from among the multiple users. For example, a conversation takes place among all of the multiple users participating in the online conferencing service in the same channel. In addition, a separate conversation takes place between specific users from among the multiple users participating in the online conferencing service in the same channel.

Hereinafter, the conversation that takes place among all of the multiple users participating in the same online conferencing service is referred to as the “overall conversation”, and the conversation that takes place separately between specific users is referred to as the “separate conversation”.

In the overall conversation, information is exchanged among all of the multiple users participating in the same online conferencing service. For example, speech uttered by a certain user in the online conferencing service is outputted to all other users participating in the online conferencing service. The speech is emitted from a speaker used by each user.

In the separate conversation, the information (speech, for example) exchanged between the specific users is outputted only to the specific users, and is not outputted to users not participating in the separate conversation.

In the online conferencing service, at least speech is exchanged among the multiple users such that the overall conversation takes place among all of the multiple users. With respect to the terminal devices 12 of the users participating in the separate conversation, the speech of the separate conversation and the speech of the overall conversation are outputted distinctly. With respect to the terminal devices of the user not participating in the separate conversation, the overall speech of the multiple users (that is, the speech being exchanged in the overall conversation) is outputted, but the speech of the separate conversation is not outputted.

In the overall conversation and the separate conversation, information other than speech, such as images, video, or text, may also be exchanged, and the information such as images, video, or text may be displayed on a display of each user's terminal device 12.

Note that the online conferencing system 10 corresponds to one example of an information processing device. Some of the processes executed by the online conferencing system 10 may also be executed by the terminal device 12.

Hereinafter, FIG. 2 will be referenced to describe a hardware configuration of the online conferencing system 10. FIG. 2 illustrates an example of a hardware configuration of the online conferencing system 10.

The online conferencing system 10 includes a communication device 14, a user interface (UI) 16, a memory 18, and a processor 20, for example.

The communication device 14 is a communication interface including components such as a communication chip or a communication circuit, and has a function of transmitting information to another device and a function of receiving information from another device. The communication device 14 may have a wireless communication function, and may also have a wired communication function.

The UI 16 is a user interface, and includes a display and an operation device. The display is a liquid crystal display (LCD), an electroluminescence (OLED) display, or the like. The operation device is a device such as a keyboard, a mouse, input keys, or a control panel. The UI 16 may also be a UI such as a touch panel combining a display with an operation device. The UI 16 may also include a microphone and a speaker.

The memory 18 is a device that establishes one or multiple storage areas that store data. For example, the memory 18 is a hard disk drive (HDD), a solid-state drive (SSD), any of various types of memory (such as RAM, DRAM, or ROM, for example), another type of storage device (such as an optical disc, for example), or a combination of the above. One or multiple memories 18 are included in the online conferencing system 10.

The processor 20 is configured to control the operation of each unit of the online conferencing system 10. The processor 20 may include a memory.

Hereinafter, FIG. 3 will be referenced to describe a hardware configuration of the terminal device 12. FIG. 3 illustrates an example of the hardware configuration of the terminal device 12.

The terminal device 12 includes a communication device 22, a UI 24, a memory 26, and a processor 28, for example.

The communication device 22 is a communication interface including components such as a communication chip or a communication circuit, and has a function of transmitting information to another device and a function of receiving information transmitted from another device. The communication device 22 may have a wireless communication function, and may also have a wired communication function.

The UI 24 is a user interface, and includes a display, an operation device, a microphone, a speaker, and a camera. The display is a liquid crystal display (LCD), an electroluminescence (OLED) display, or the like. The operation device is a device such as a keyboard, a mouse, input keys, or a control panel. The UI 24 may also be a UI such as a touch panel combining a display with an operation device.

The memory 26 is a device that establishes one or multiple storage areas that store data. For example, the memory 26 is a hard disk drive (HDD), a solid-state drive (SSD), any of various types of memory (such as RAM, DRAM, or ROM, for example), another type of storage device (such as an optical disc, for example), or a combination of the above. One or multiple memories 26 are included in each terminal device 12.

The processor 28 is configured to control the operation of each component of each terminal device 12. The processor 28 may also include a memory.

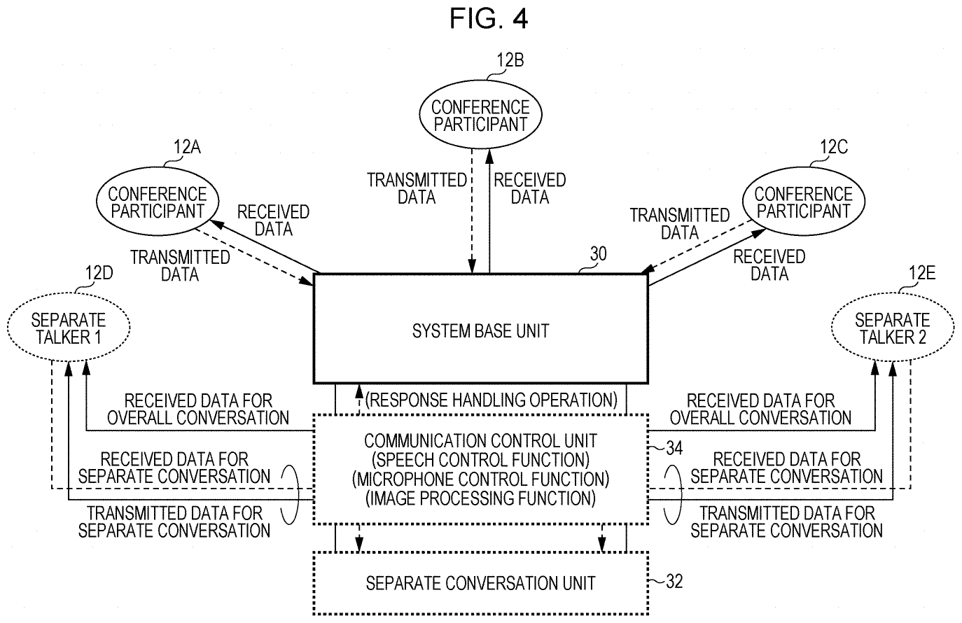

Hereinafter, FIG. 4 will be referenced to describe functions of the online conferencing system 10 related to the overall conversation and the separate conversation. FIG. 4 is a block diagram illustrating functions of the online conferencing system 10 related to the overall conversation and the separate conversation.

In the following, the users participating in the overall conversation but not participating in the separate conversation are referred to as the “conference participants”, and the specific users participating in the separate conversation are referred to as the “separate talkers”. The separate conversation occurs between multiple separate talkers participating in the overall conversation. In other words, the separate talkers participate in the separate conversation while also participating in the overall conversation.

In the example illustrated in FIG. 4, a conference participant 1 uses the terminal device 12A, a conference participant 2 uses the terminal device 12B, a conference participant 3 uses the terminal device 12C, a separate talker 1 uses the terminal device 12D, and a separate talker 2 uses the terminal device 12E. Each participant uses his or her own terminal device 12 to participate in the same online conferencing service (for example, an online conferencing service in the same channel). The separate talkers 1 and 2 are participating in the same separate conversation.

The online conferencing system 10 includes a system base unit 30, a separate conversation unit 32, and a communication control unit 34. These units are achieved by the processor 20 of the online conferencing system 10.

The system base unit 30 has a function of achieving the overall conversation. Specifically, the system base unit 30 transmits and receives, through a communication channel, information such as speech, images, and video with respect to the terminal devices 12 (for example, the terminal devices 12A, 12B, 12C, 12D, and 12E) of all users participating in the same online conferencing service. In other words, through the communication channel, the system base unit 30 receives information such as speech, images, and video from the terminal devices 12 of all users participating in the same online conferencing service, and transmits information such as speech, images, and video to the terminal devices 12 of all users participating in the same online conferencing service. For example, the system base unit 30 receives information (speech, for example) transmitted from the terminal device 12A, and transmits the information to the terminal devices 12B, 12C, 12D, and 12E. In this way, in the overall conversation, information such as speech, images, and video is shared by all users participating in the overall conversation.

The separate conversation unit 32 has a function of achieving the separate conversation. Specifically, the separate conversation unit 32 transmits and receives, through a communication channel, information such as speech, images, and video with respect to the terminal devices 12 of the multiple specific users engaged in the separate conversation. In other words, through the communication channel, the separate conversation unit 32 receives information such as speech, images, and video from the terminal device 12 of a specific user engaged in the separate conversation, and transmits the received information to the terminal device 12 of another specific user engaged in the separate conversation. The separate conversation unit 32 also manages the requesting and accepting of separate conversations.

For example, the separate conversation unit 32 receives information (speech, for example) transmitted from the terminal device 12D of the separate talker 1, and transmits the information to the terminal device 12E of the separate talker 2. Similarly, the separate conversation unit 32 receives information transmitted from the terminal device 12E of the separate talker 2, and transmits the information to the terminal device 12D of the separate talker 1.

The communication control unit 34 has a speech control function, a microphone control function, and an image processing function, and controls processes such as the output of speech, the output from a microphone, sound pickup by a microphone, and the processing of images generated by image capture performed by a camera.

The speech control function controls the output of the speech of the overall conversation and the speech of the separate conversation according to the functions of a speaker (for example, a speaker in the terminal device 12) used by the separate talker engaged in the separate conversation in the online conferencing service.

If the speaker used in the online conferencing service by a separate talker engaged in the separate conversation (for example, the speaker in the separate talker's terminal device 12) is a stereo speaker, the speech control function outputs the speech of the separate conversation and the speech of the overall conversation from respectively different channels of the stereo speaker.

If the speaker used in the online conferencing service by a separate talker engaged in the separate conversation (for example, the speaker in the separate talker's terminal device 12) is a monaural speaker, the speech control function raises the volume of the speech of the separate conversation higher than the volume of the speech of the overall conversation, and outputs the speech of the overall conversation and the speech of the separate conversation from the monaural speaker. If the speech of the separate conversation is silent, the speech control function outputs the speech of the overall conversation at a normal volume (that is, without changing the volume of the speech of the overall conversation).

The microphone control function controls output and sound pickup by a microphone (for example, a microphone in the terminal device 12) used by the separate talker engaged in the separate conversation in the online conferencing service.

Specifically, the microphone control function sets the output destination of sound picked up by a microphone used by a separate talker engaged in the separate conversation (for example, a microphone in the separate talker's terminal device 12) to only the terminal device 12 used by another separate talker engaged in the same separate conversation. In other words, during a separate conversation, the microphone control function mutes the output to the overall conversation from the microphone used by a separate talker, and sets the output destination of sound picked up by the microphone to only a separate talker.

In the case where the separate talker is asked for a response from the conference participants participating in the overall conversation, the microphone control function sets the output destination of the microphone used by the separate talker to the overall conversation while a “response handling operation” is ongoing during the separate conversation. If the “response handling operation” ends, the microphone control function sets the output destination of the microphone used by the separate talker to only the terminal device 12 used by another separate talker engaged in the same separate conversation. The “response handling operation” will be described in detail later.

The image processing function is a function executed in the case where images of users participating in the online conferencing service are transmitted and received in the online conferencing service. Specifically, in the case where an image is captured by a camera used by the separate talker (for example, a camera in the separate talker's terminal device 12) in the online conferencing service, the image processing function processes the image generated by the image capture performed by the camera. For example, the image processing functions alters the mouth of the separate talker appearing in the image to generate an image in which the mouth does not appear to be moving.

The communication control unit 34 transmits the processed image to the terminal devices 12 of the conference participants participating in the overall conversation but not participating in the separate conversation, and causes the processed image to be displayed on the display of each terminal device 12 of the conference participants. The communication control unit 34 transmits the unprocessed real image to the terminal device 12 of the separate talker engaged in the separate conversation, and causes the unprocessed image to be displayed on the display of the separate talker's terminal device 12.

The “received data” and the “data for overall conversation” illustrated in FIG. 4 are the information exchanged in the overall conversation (such as speech, images, and video, for example), and are the information received by the terminal devices 12 of the users participating in the overall conversation (for example, the conference participants and the separate talkers). The received data and the data for overall conversation are shared by the users participating in the overall conversation.

The “transmitted data” represents the information (such as speech, images, and video, for example) transmitted to the overall conversation by the terminal devices 12 of the conference participants participating in the overall conversation.

The “received data for separate conversation” is the information (such as speech, images, and video, for example) exchanged in the separate conversation, and is the information received by the terminal devices 12 of the separate talkers participating in the separate conversation. The received data for separate conversation is only shared with the separate talkers, and is not shared with users other than the separate talkers.

The “transmitted data for separate conversation” is the information (such as speech, images, and video, for example) transmitted to the separate conversation by the terminal devices 12 of the separate talkers engaged in the separate conversation.

Note that all or part of the speech control function, the microphone control function, and the image processing function may also be achieved by the processor 28 of each terminal device 12. Additionally, some or all of the functions of the separate conversation unit 32 may also be achieved by the processor 28 of each terminal device 12.

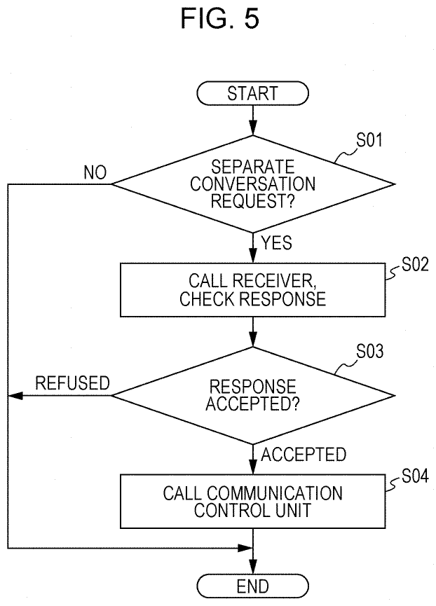

Hereinafter, FIG. 5 will be referenced to describe processes by the separate conversation unit 32. FIG. 5 is a flowchart illustrating a flow of processes by the separate conversation unit 32.

The separate conversation unit 32 monitors the terminal device 12 of each user participating in the overall conversation, and if a separate conversation request from a terminal device 12 is detected (S01, Yes), the separate conversation unit 32 calls the receiver on the other end of the separate conversation, and asks the receiver for confirmation about whether to accept or refuse the separate conversation (S02). The receiver is a user participating in the overall conversation. For example, if a certain user uses his or her own terminal device 12 to specify the other end of a separate conversation and request the online conferencing system 10 to execute a separate conversation, the separate conversation unit 32 receives the request and transmits query information about whether or not to start the separate conversation to the terminal device 12 of the receiver on the other end of the separate conversation. Hereinafter, the user who requests the separate conversation may also be referred to as the “initiator”.

The receiver receives the query about whether or not to start the separate conversation, and uses his or her own terminal device 12 to accept or refuse the separate conversation (S03). For example, information indicating the query is displayed on the display of the receiver's terminal device 12, and the receiver responds to the query. Information indicating acceptance or refusal is transmitted from the receiver's terminal device 12 to the online conferencing system 10.

In the case where the receiver accepts the separate conversation (S03, Accepted), the separate conversation unit 32 calls the communication control unit 34 (S04).

In the case where the receiver refuses the separate conversation (S03, Refused), the process ends. Also, in the case where a separate conversation request is not detected (S01, No), the process ends.

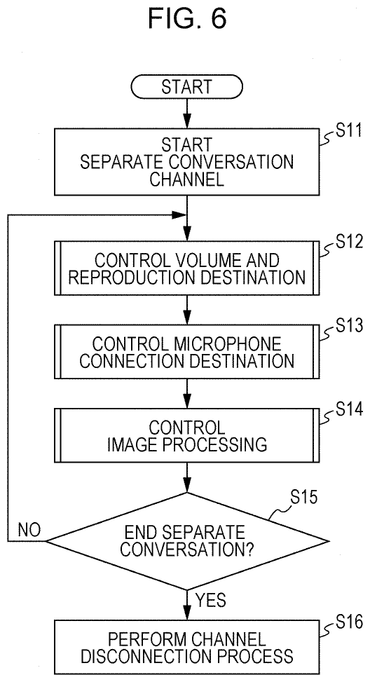

Hereinafter, FIG. 6 will be referenced to describe processes by the communication control unit 34. FIG. 6 is a flowchart illustrating a flow of processes by the communication control unit 34.

If the separate conversation is accepted as described above, the separate conversation unit 32 creates a channel for the separate conversation between the terminal device 12 of the conference participant who requested the separate conversation (in other words, the initiator) and the terminal device 12 of the conference participant who received the separate conversation request and accepted the separate conversation (in other words, the receiver) (S11). With this arrangement, the conference participant who requested the separate conversation and the conference participant who accepted the separate conversation engage in a separate conversation as separate talkers.

The speech control function of the communication control unit 34 checks the functions of the speaker used by the separate talker who engages in the separate conversation, and controls the output of the speech of the overall conversation and the speech of the separate conversation according to the functions (S12).

The microphone control function of the communication control unit 34 sets the output destination of the microphone used by the separate talker engaged in the separate conversation to the channel for the separate conversation, and sets the output destination of the microphone to the overall conversation while the response handling operation is ongoing (S13).

In the case where an image is being captured by the camera used by the separate talker, the image processing function of the communication control unit 34 processes an image of the separate talker's face outputted to the overall conversation (S14).

If the separate conversation has not ended (S15, No), the process returns to step S12. If the separate conversation has ended (S15, Yes), the separate conversation unit 32 disconnects the channel for the separate conversation (S16). The communication control unit 34 reverts the settings of the speaker and the microphone used by the separate talker to the settings from before the separate conversation.

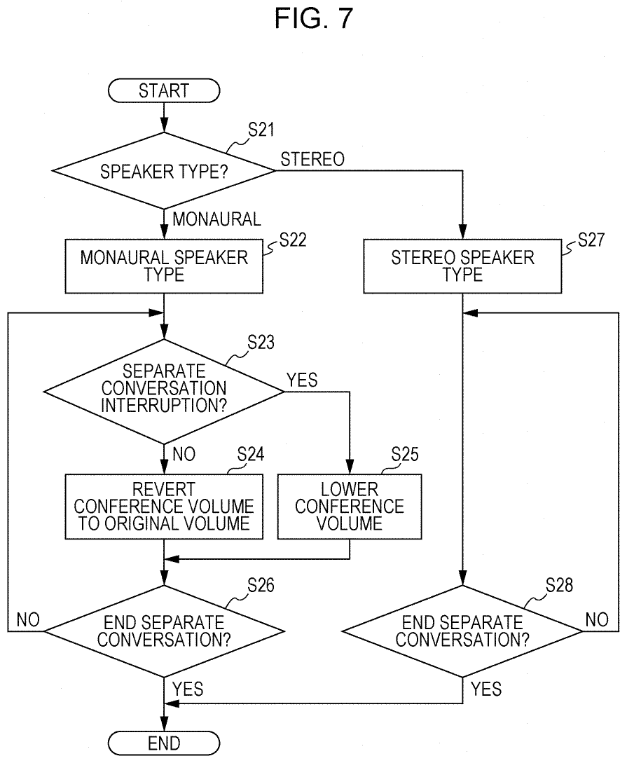

Hereinafter, FIGS. 7 to 9 will be referenced to describe each of the processes from steps S12 to S14 in detail.

FIG. 7 will be referenced to describe processes by the speech control function of the communication control unit 34. FIG. 7 is a flowchart illustrating a flow of processes by the speech control function.

First, the speech control function of the communication control unit 34 checks the type of the speaker used by the separate talker (for example, the speaker in the terminal device 12 used by the separate talker) (S21).

If the speaker used by the separate talker is a monaural speaker (S21, Monaural), the speech control function controls the output of speech according to the monaural speaker type (S22).

In a situation without a separate conversation interruption (S23, No), the speech control function outputs the speech of the overall conversation (for example, the conversation of the conference as a whole) at a normal volume (that is, without changing the volume of the speech of the overall conversation) (S24). For example, if the speech of the separate conversation is silent, the speech control function outputs the speech of the overall conversation at a normal volume.

In the case of detecting a separate conversation interruption (S23, Yes), the speech control function lowers the volume of the speech of the overall conversation (for example, the conversation of the conference as a whole), raises the volume of the speech of the separate conversation higher than the volume of the speech of the overall conversation, and outputs the speech of the overall conversation and the speech of the separate conversation from the monaural speaker (S25). In this way, the speech control function prioritizes the output of the speech of the separate conversation over the output of the speech of the overall conversation. In the case of detecting that the separate conversation is silent, the speech control function revers the volume of the speech of the overall conversation to a normal volume.

If the separate conversation has not ended (S26, No), the process returns to step S23 and the speech control function controls the output of speech according to the monaural speaker type. If the separate conversation has ended (S26, Yes), the processes by the speech control function end.

If the speaker used by the separate talker is a stereo speaker (S21, Stereo), the speech control function controls the output of speech according to the stereo speaker type (S27). Namely, the speech control function outputs the speech of the separate conversation and the speech of the overall conversation from respectively separate channels in the stereo speaker. For example, the speech control function outputs the speech of the separate conversation from one channel in the stereo speaker and outputs the speech of the overall conversation from another channel in the stereo speaker, and thereby outputs the speech of the separate conversation and the speech of the overall conversation separately.

If the separate conversation has not ended (S28, No), the speech control function controls the output of speech according to the stereo speaker type. If the separate conversation has ended (S28, Yes), the processes by the speech control function end.

The speech control function checks the type of speaker used by each of the initiator and the receiver described above, and controls the output of speech from each speaker according to the monaural speaker method or the stereo speaker method.

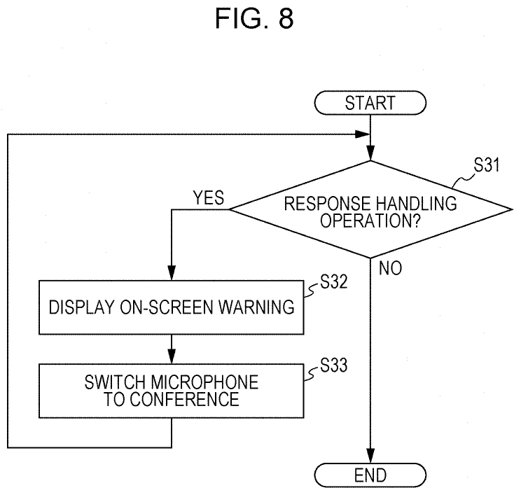

FIG. 8 will be referenced to describe processes by the microphone control function of the communication control unit 34. FIG. 8 is a flowchart illustrating a flow of processes by the microphone control function.

The microphone control function sets the output destination of sound picked up by the microphone used by the separate talker (for example, the microphone in the separate talker's terminal device 12) to only the terminal device 12 used by another separate talker engaged in the same separate conversation. For example, the microphone control function sets the output destination of sound picked up by the microphone used by the initiator to only the receiver's terminal device 12, and sets the output destination of sound picked up by the microphone used by the receiver to only the initiator's terminal device 12. With this arrangement, the speech of the separate conversation is exchanged only between the separate talkers.

In the case where the “response handling operation” is not being performed during the separate conversation (S31, No), the processes related to the “response handling operation” end.

In the case where the processes of the “response handling operation” are set to active during the separate conversation (S31, Yes), the microphone control function causes a warning to be displayed on the display of the terminal devices 12 used by each of the initiator and the receiver (S32). For example, warning information indicating that the separate conversation has been suspended is displayed on each display.

While the processes of the “response handling operation” are set to active, the microphone control function switches the output destination of the microphone used by the separate talker performing the “response handling operation” to the overall conversation (for example, the conversation of the conference as a whole) (S33). For example, the “response handling operation” functions only while a specific key or on-screen button is being pressed, and does not function if the specific key or on-screen button is not being pressed.

If the “response handling operation” ends, the microphone control function sets the output destination of the microphone used by the separate talker to only the terminal device 12 used by another separate talker engaged in the same separate conversation.

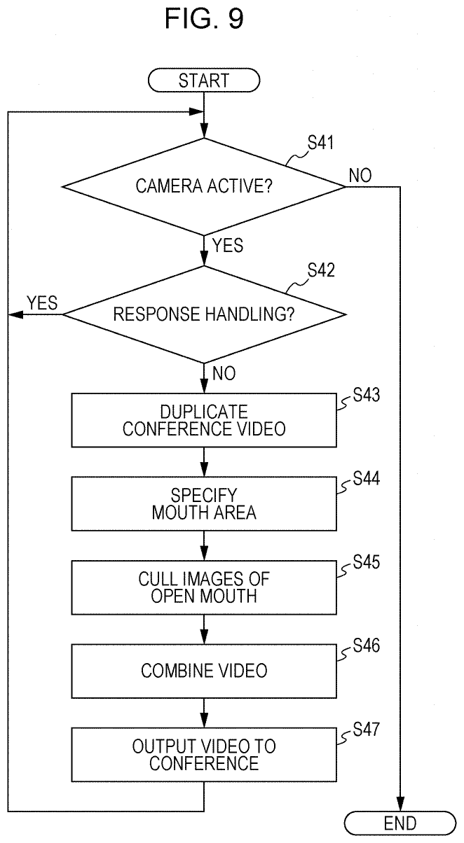

FIG. 9 will be referenced to describe processes by the image processing function of the communication control unit 34. FIG. 9 is a flowchart illustrating a flow of processes by the image processing function.

The image processing function checks whether or not the camera used by the separate talker (such as an inward-facing camera installed in the separate talker's terminal device 12, for example) is active (S41). For example, the camera is set to active in the case where the camera is powered on and a setting that outputs an image generated by image capture performed by the camera to the online conferencing service is on. The camera is set to inactive in the case where the camera is powered off or the setting that outputs the image to the online conferencing service is off.

In the case where the camera is not active (S41, No), the processes by the image processing function end.

In the case where the camera is active (S41, Yes), if the “response handling operation” is being performed (S42, Yes), the process returns to step S41. In this case, the image generated by the image capture performed by the camera is transmitted to the terminal devices 12 of the other conference participants without being altered by the image processing function, and is displayed on the display in the terminal devices 12 of the other conference participants. For example, in the case where an image of the separate talker's face is captured by the camera, the real image is displayed on the display in the terminal devices 12 of the other conference participants without altering the image of the face.

In the case where the camera is active (S41, Yes), if the “response handling operation” is not being performed (S42, No), the image processing function duplicates a video for the overall conversation (that is, for the conversation of the conference as a whole) (S43). In other words, the image processing function duplicates a video generated by the image capture performed by the camera used by the separate talker in real time for the overall conversation (S43).

Next, the image processing function specifies the mouth area of the face from the duplicated video, and sets the specified mouth area as a processing area (S44).

Next, the image processing function culls images of open mouths from the duplicated video (S45).

Next, the image processing function combines the video (S46). Specifically, the image processing function combines the video by interpolating images of the mouth area on the basis of a preceding image (that is, an image of a closed mouth) preceding the image of the open mouth and a succeeding image (that is, an image of a closed mouth) succeeding the image of the open mouth. In this way, the image processing function generates a video in which the mouth is not open.

Next, the communication control unit 34 outputs the processed video as a video image of the separate talker him- or herself to the overall conversation (that is, the conversation of the conference as a whole) (S47). In other words, the communication control unit 34 transmits the processed video to the terminal devices 12 of the conference participants participating in the overall conversation but not participating in the separate conversation, and causes the processed video to be displayed on the display of each terminal device 12 of the conference participants. The communication control unit 34 transmits the unprocessed real video to the terminal device 12 of the separate talker engaged in the separate conversation, and causes the unprocessed video to be displayed on the display of the separate talker's terminal device 12. After that, the process returns to step S41.

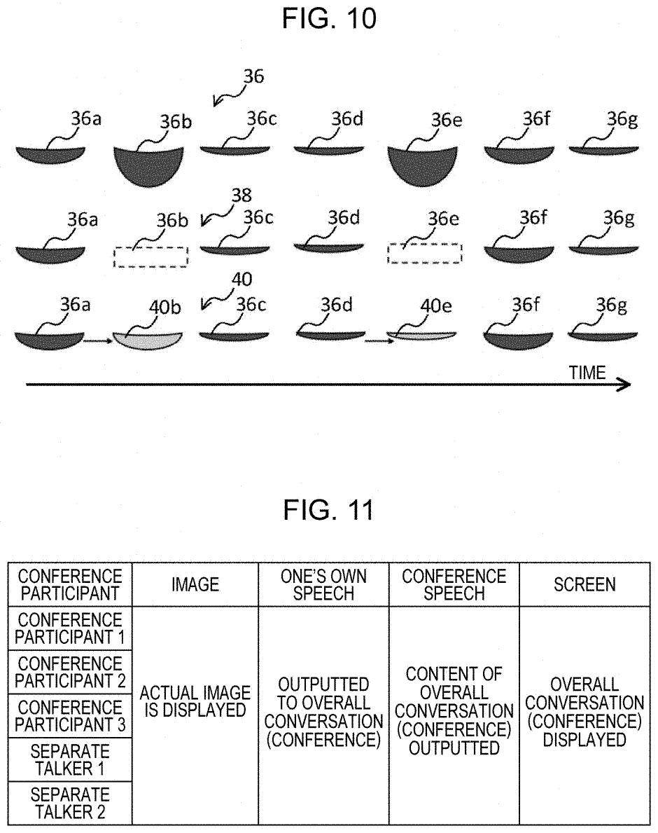

FIG. 10 will be referenced to describe a specific example of processes by the image processing function. FIG. 10 illustrates the mouth area of the face of the separate talker.

A video 36 is a video generated by image capture performed by the camera used by a certain separate talker, and is a video before culling. The video 36 contains multiple frames (that is, images). In the example illustrated in FIG. 10, frames 36a to 36g included in the video 36 are illustrated. Images are captured in order from the frame 36a to the frame 36g, and among the frames 36a to 36g, the frame 36a is the oldest frame while the frame 36g is the newest frame.

In the video 36, the frames 36b and 36e illustrate an open mouth, while the frames 36a, 36c, 36d, 36f, and 36g illustrate a closed mouth.

A video 38 is obtained by culling the frames 36b and 36e of an open mouth from the video 36.

A video 40 is a video obtained after performing interpolation. The frame 36a preceding the frame 36b is inserted at the position of the culled frame 36b as a frame 40b, and the frame 36d preceding the frame 36e is inserted at the position of the culled frame 36e as a frame 40e. The frames 36a and 36d are frames of a closed mouth. By replacing the frame at the position where the frame 36b was located with the frame 36a of a closed mouth, a frame is interpolated at the position where the frame 36b was located. Similarly, by replacing the frame at the position where the frame 36e was located with the frame 36d of a closed mouth, a frame is interpolated at the position where the frame 36e was located. Through such interpolation, the video 36 is processed to generate the video 40. Note that the mouth area, an open mouth, and a closed mouth are specified by using known image processing technology.

The communication control unit 34 transmits the processed video 40 as a video of the separate talker him- or herself to the terminal devices 12 of the conference participants participating in the overall conversation but not participating in the separate conversation, and causes the processed video 40 to be displayed on the display of each terminal device 12 of the conference participants. The communication control unit 34 transmits the unprocessed real video 36 to the terminal device 12 of the separate talker engaged in the separate conversation, and causes the unprocessed video to be displayed on the display of the separate talker's terminal device 12.

Hereinafter, a specific example of the exemplary embodiment will be described with reference to FIGS. 11 to 16.

FIG. 11 illustrates a list of conference participants.

Here, as an example, five users (for example, conference participants 1 to 3 and separate talkers 1, 2) are participating in the same online conferencing service. The conference participants 1 to 3 are participating in the overall conversation but are not engaged in the separate conversation. The separate talkers 1, 2 are engaged in the separate conversation while also participating in the overall conversation. The separate talker 1 is the initiator who requests the separate talker 2 for the separate conversation, and the separate talker 2 is the receiver who receives the separate conversation request from the separate talker 1.

For example, the conference participant 1 uses the terminal device 12A to participate in the online conferencing service, the conference participant 2 uses the terminal device 12B to participate in the online conferencing service, the conference participant 3 uses the terminal device 12C to participate in the online conferencing service, the separate talker 1 uses the terminal device 12D to participate in the online conferencing service, and the separate talker 2 uses the terminal device 12E to participate in the online conferencing service.

FIG. 11 illustrates the outputs before the separate conversation takes place. Here, as an example, assume that the cameras used respectively by the conference participants 1 to 3 and the separate talkers 1, 2 are set to active. The conference participants 1 to 3 and the separate talkers 1, 2 are captured by the respective cameras in their own terminal devices 12, and real images generated by the image capture are displayed in the overall conversation (that is, the conference as a whole). Also, the speech of each of the conference participants 1 to 3 and the separate talkers 1, 2 (in FIG. 11, One's Own Speech) is outputted to the overall conversation (that is, the conference as a whole), and the speech of the overall conversation (in FIG. 11, Conference Speech) is outputted from the respective speakers of the conference participants 1 to 3 and the separate talkers 1, 2. Also, objects displayed in the overall conversation are displayed on the respective displays of the terminal devices 12 used by the conference participants 1 to 3 and the separate talkers 1, 2. In this way, when the separate conversation is not taking place, images generated by image capture performed by the cameras, speech, and screens are shared by the conference participants 1 to 3 and the separate talkers 1, 2.

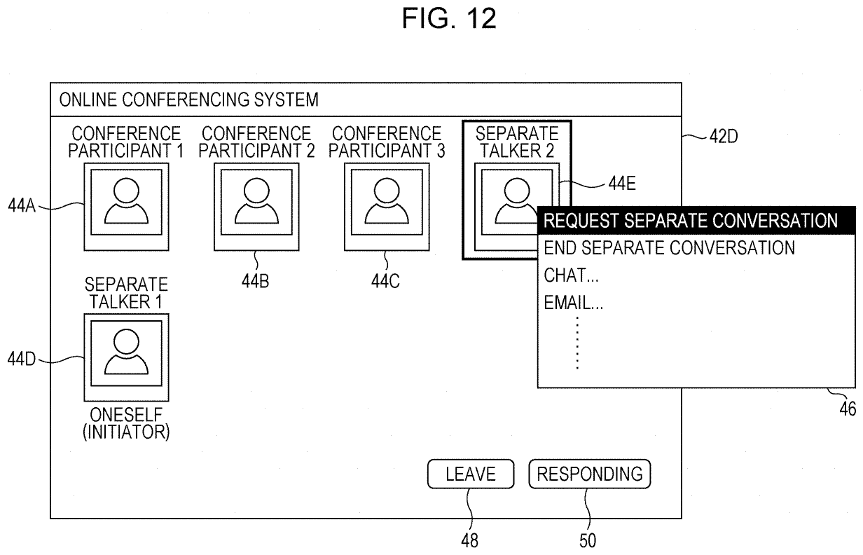

Hereinafter, FIG. 12 will be referenced to describe a screen displayed while the online conferencing service is in use. A screen 42D is illustrated in FIG. 12. The screen 42D is displayed on the display of the terminal device 12D used by the separate talker 1. Screens similar to the screen 42D are also displayed on the respective displays of the terminal devices 12 used by the conference participants 1 to 3 and the separate talker 2.

On the screen 42D, images representing the users participating in the same online conferencing service are displayed. An image 44A is an image representing the conference participant 1, and is generated by image capture performed by the camera in the terminal device 12A. An image 44B is an image representing the conference participant 2, and is generated by image capture performed by the camera in the terminal device 12B. An image 44C is an image representing the conference participant 3, and is generated by image capture performed by the camera in the terminal device 12C. An image 44D is an image representing the separate talker 1, and is generated by image capture performed by the camera in the terminal device 12D. An image 44E is an image representing the separate talker 2, and is generated by image capture performed by the camera in the terminal device 12E. Note that the images 44A to 44E may also be video images. Here, the images 44A to 44E are assumed to include video.

The images (that is, the images 44A, 44B, 44C) of the conference participants 1, 2, 3 not engaged in the separate conversation are generated by image capture performed by the respective cameras, and are unprocessed real images. In the case where the separate conversation is not taking place, the images (that is, the images 44D, 44E) of the separate talkers 1, 2 are generated by image capture performed by the respective cameras, and are unprocessed real images. In this way, images representing each of the participants are shared by all of the conference participants 1 to 3 and the separate talkers 1, 2.

The speech of each participant is outputted to the overall conversation, that is, to all other participants. For example, in the case where the separate conversation is not taking place, the speech of the separate talker 1 is outputted to the conference participants 1 to 3 and the separate talker 2, and is emitted from the respective speakers of the conference participants 1 to 3 and the separate talker 2. The same applies to the other participants. In this way, the speech of each of the participants is shared by all of the conference participants 1 to 3 and the separate talkers 1, 2.

Also, objects (such as documents and images, for example) displayed on the screen are displayed on the respective displays of the terminal devices 12 of the conference participants 1 to 3 and the separate talkers 1, 2, and are shared by all of the conference participants 1 to 3 and the separate talkers 1, 2.

If the separate talker 1 uses his or her own terminal device 12D to specify the separate talker 2 as the other end of the separate conversation on the screen 42D (for example, if the separate talker 1 clicks, touches, or taps the image 44E of the separate talker 2), the processor 20 of the online conferencing system 10 displays a menu 46 on the screen 42D. On the menu 46, a button for requesting the separate conversation, a button for ending the separate conversation, a button for chat, a button for email, and the like are displayed.

If the separate talker 1 selects and presses the “Request separate conversation” button from the menu 46 (for example, if the separate talker 1 clicks, touches, or taps the button), the separate conversation unit 32 causes information indicating that the separate talker 1 is requesting a separate conversation with the separate talker 2 to be displayed on the display in the terminal device 12E used by the separate talker 2. If the separate talker 2 uses the terminal device 12E to give an instruction for accepting the separate conversation with the separate talker 1 in response to the request, the separate conversation unit 32 receives the acceptance of the separate conversation and creates a channel for the separate conversation between the separate talker 1 and the separate talker 2. Thereafter, the processes from steps S12 to S15 illustrated in FIG. 6 are executed, and the separate conversation takes place between the separate talker 1 and the separate talker 2.

In the case where the separate talker 2 refuses the separate conversation with the separate talker 1, the separate conversation unit 32 does not create a channel for the separate conversation between the separate talker 1 and the separate talker 2.

Note that in some cases, a certain participant (for example, the separate talker 2) may receive separate conversation requests from multiple different participants. In this case, the participant receiving the requests may select a participant to engage in a separate conversation with from among the multiple different participants and accept the separate conversation with the selected participant, or refuse all of the requests from the multiple different participants.

Additionally, a separate conversation may also take place among three or more participants. For example, while a separate conversation is taking placed between the separate talkers 1 and 2, the separate talker 1 or the separate talker 2 may request another participant to join the same separate conversation taking place between the separate talkers 1 and 2. If the other participant accepts the request to join, the separate conversation takes places among the separate talkers 1, 2 and the other participant. In this case, if a separate talker (for example, the separate talker 2) other than the separate talker (for example, the separate talker 1) who requested the other participant to join accepts the participation by the other participant, the other participant is allowed to join the separate conversation.

A button 48 and a button 50 are also displayed on the screen 42D. The button 48 is for leaving the online conferencing service. If the button 48 is pressed, the participant pressing the button 48 leaves the online conferencing service. The button 50 is for responding. Responding will be described later.

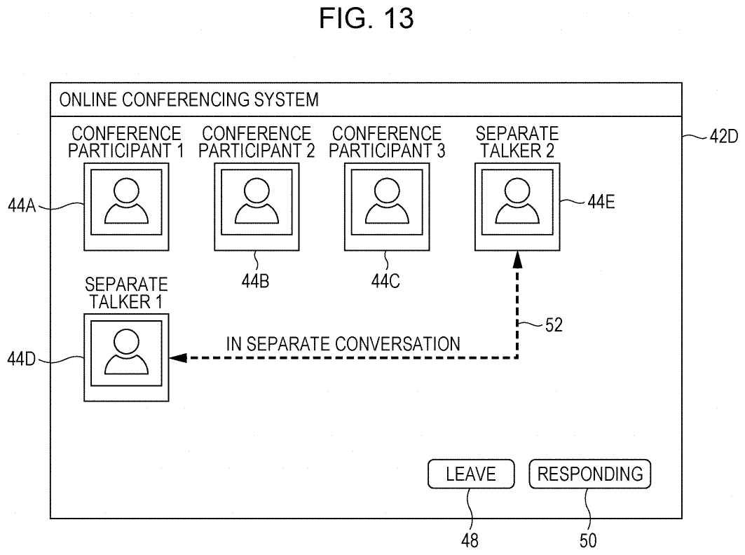

FIG. 13 illustrates the screen 42D during a separate conversation.

In the case where a separate conversation is taking place between the separate talkers 1 and 2, the separate conversation unit 32 causes information (text and an image, for example) indicating that the separate talkers 1 and 2 are engaged in the separate conversation to be displayed only on the display in the terminal device 12D used by the separate talker 1 and the terminal device 12E used by the separate talker 2. For example, as indicated by the sign 52, a line connecting the image 44D with the image 44E and text indicating that a separate conversation is taking place are displayed on the screen 42D. Similar information is also displayed on the screen displayed with respect to the separate talker 2. Information indicating that the separate talkers 1 and 2 are engaged in a separate conversation is not displayed on the respective displays in the terminal devices 12 of the conference participants 1 to 3.

During the separate conversation, the output of speech is controlled by the processes illustrated in FIG. 7, the output from the microphone is controlled by the processes illustrated in FIG. 8, and the output of images is controlled by the processes illustrated in FIG. 9.

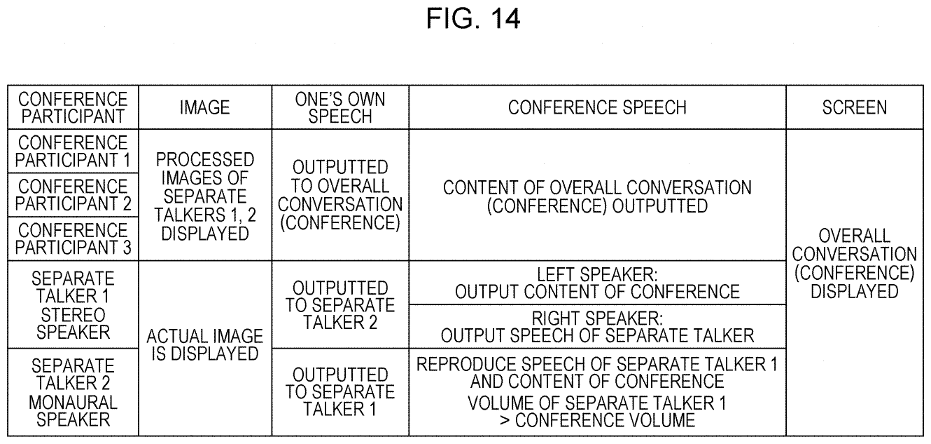

FIG. 14 illustrates the outputs while the separate conversation is taking place between the separate talkers 1 and 2.

Processed images of the separate talkers 1 and 2 are transmitted to the respective terminal devices 12 (that is, the terminal devices 12A, 12B, and 12C) of the conference participants 1 to 3, and the processed images of the separate talkers 1 and 2 are displayed on the respective displays in the terminal devices 12A, 12B, and 12C. For example, the images 44D and 44E displayed on the respective displays of the terminal devices 12A, 12B, and 12C are images that have been processed by the image processing function of the communication control unit 34. As described with reference to FIGS. 9 and 10, the separate talker 1 with a closed mouth is displayed in the image 44D and the separate talker 2 with a closed mouth is displayed in the image 44E. In other words, the image 44D displayed on the respective displays of the terminal devices 12A, 12B, and 12C is not the real image generated by the image capture performed by the camera in the terminal device 12D used by the separate talker 1, but rather is a n image generated by the image processing function processing the real image. The same applies to the image 44E.

Real images of the separate talkers 1 and 2 are transmitted to the respective terminal devices 12 (that is, the terminal devices 12D and 12E) of the separate talkers 1 and 2, and the real images of the separate talkers 1 and 2 are displayed on the respective displays of the terminal devices 12D and 12E. For example, the images 44D and 44E displayed on the respective displays of the terminal devices 12D and 12E are real images generated by image capture. In other words, the image 44D displayed on the respective displays of the terminal devices 12D and 12E is a real image generated by image capture performed by the camera in the terminal device 12D. The same applies to the image 44E.

Real images of each of the conference participants 1 to 3 are displayed on the respective displays of the terminal devices 12A, 12B, 12C, 12D, and 12E. In other words, the images 44A, 44B, and 44C displayed on the respective displays of the terminal devices 12A, 12B, 12C, 12D, and 12E are real images generated by image capture performed by the cameras.

The speech of each of the conference participants 1 to 3 (in FIG. 14, One's Own Speech) is outputted to the overall conversation (the conference as a whole). In other words, sound picked up by the respective microphones of the conference participants 1 to 3 is outputted to all participants, or in other words to the terminal devices 12A, 12B, 12C, 12D, and 12E, and emitted from the respective speakers in the terminal devices 12A, 12B, 12C, 12D, and 12E.

The speech of the separate talker 1 (in FIG. 14, One's Own Speech) is outputted to the separate talker 2. In other words, sound picked up by the microphone of the separate talker 1 is outputted only to the separate talker 2, or in other words only to the terminal device 12E, and emitted from the speaker in the terminal device 12E. Similarly, the speech of the separate talker 2 is outputted to the separate talker 1. In other words, sound picked up by the microphone of the separate talker 2 is outputted only to the separate talker 1, or in other words only to the terminal device 12D, and emitted from the speaker in the terminal device 12D. With this arrangement, the speech of the separate talker 1 is outputted only to the separate talker 2, and the speech of the separate talker 2 is outputted only to the separate talker 1.

The overall conversation (that is, the conversation of the conference as a whole) is emitted from the respective speakers in the terminal devices 12 (that is, the terminal devices 12A, 12B, and 12C) of the conference participants 1 to 3.

The speaker in the terminal device 12D of the separate talker 1 is a stereo speaker, and therefore speech is outputted from the speaker in the terminal device 12D according to the stereo speaker method (see FIG. 7). For example, the speech of the overall conversation is outputted from the left speaker, and the speech of the separate talker 2 on the other end of the separate conversation is outputted from the right speaker.

The speaker in the terminal device 12E of the separate talker 2 is a monaural speaker, and therefore speech is outputted from the speaker in the terminal device 12E according to the monaural speaker method (see FIG. 7). Specifically, when the speech of the separate talker 1 is outputted, the volume of the speech of the separate talker 1 is raised higher than the volume of the overall conversation, and the speech of the separate talker 1 is outputted from the speaker.

Note that a screen for the separate conversation may also be displayed on the displays in the terminal devices 12 of the separate talkers and shared by only the separate talkers. For example, a screen for the separate conversation is displayed only on the respective displays in the terminal devices 12D and 12E, and information displayed on the screen for the separate conversation is shared by only the separate talkers 1 and 2.

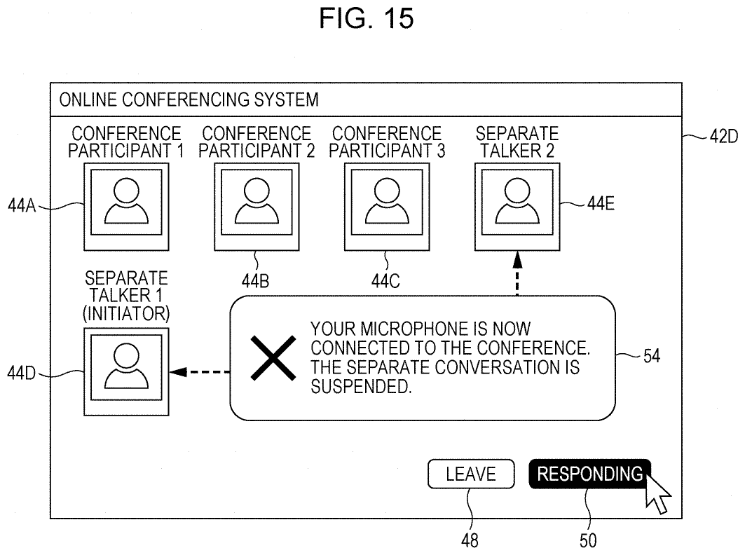

Hereinafter, FIG. 15 will be referenced to describe the response handling operation. The screen 42D is illustrated in FIG. 15.

As described above, the communication control unit 34 outputs the speech of the separate talker (for example, the separate talker 1) engaged in a separate conversation only to the terminal device 12 (for example, the terminal device 12E) of the other separate talker (for example, the separate talker 2) engaged in the same separate conversation. In this case, when the separate talker (for example, the separate talker 1) responds to the overall conversation, the communication control unit 34 suspends the separate conversation and outputs the speech of the separate talker to the overall conversation. For example, the speech of the separate talker 1 is outputted to the respective terminal devices 12 of the conference participants 1 to 3 and the separate talker 2, and is emitted from the speaker in each terminal device 12.

The communication control unit 34 causes an image for suspending the separate conversation and responding to the overall conversation to be displayed on the display in the terminal device 12 of the separate talker. The communication control unit 34 may also cause the image to be displayed on the displays of the terminal devices 12 of all participants participating in the online conferencing service. If the image is operated by the separate talker, the communication control unit 34 suspends the separate conversation and outputs the speech of the separate talker to the overall conversation.

The button 50 for responding is one example of an image for suspending the separate conversation and responding to the separate conversation. The communication control unit 34 outputs the speech of the separate talker to the overall conversation while the button 50 is being pressed by the separate talker, and outputs the speech of the separate talker only to the other end of the separate conversation when the button 50 is not being pressed.

Additionally, in the case where the separate talker responds to the overall conversation, or in other words, in the case where the button 50 is being pressed, the communication control unit 34 treats an unprocessed image of the separate talker (that is, a real image generated by image capture performed by the camera in the terminal device 12 used by the separate talker) as an image representing the separate talker, and causes the image to be displayed on the displays in the terminal devices 12 of the other participants.

For example, suppose that while the separate talkers 1 and 2 are engaged in the separate conversation, a conference participant (for example, the conference participant 1) calls out to the separate talker 1 (by, for example, saying something like “I'd like to hear Separate Talker 1's opinion”). The conference participant 1 calls out to the separate talker 1 through the overall conversation. Since the speaker of the separate talker 1 is a stereo speaker and the speech of the overall conversation is emitted from one channel, the separate talker 1 is able to recognize that the conference participant 1 is calling out to the separate talker 1.

To respond to being called out, the separate talker 1 presses the button 50 on the screen 42D. While the button 50 is being pressed, the communication control unit 34 switches the output destination of the microphone used by the separate talker 1 to the overall conversation. With this arrangement, utterances by the separate talker 1 are outputted to the overall conversation, or in other words to the respective terminal devices 12 (that is, the terminal devices 12A, 12B, 12C, and 12E) of the conference participants 1 to 3 and the separate talker 2, and are emitted from the respective speakers in the terminal devices 12A, 12B, 12C, and 12E. In this case, as illustrated in FIG. 15, the communication control unit 34 causes information such as the message 54 indicating that the separate conversation is suspended to be displayed on the respective displays in the terminal devices 12 (that is, the terminal devices 12D and 12E) of the separate talkers 1 and 2. The message 54 is not displayed on the respective displays in the terminal devices 12 of the conference participants 1 to 3. Similarly, the communication control unit 34 switches the output destination of the microphone used by the separate talker 2 on the other end of the separate conversation to the overall conversation. With this arrangement, utterances by the separate talker 2 are outputted to the overall conversation.

Also, while the separate talker 1 is pressing the button 50, the communication control unit 34 causes the real image 44D (that is, the image 44D not processed by the image processing function) generated by image capture performed by the camera in the terminal device 12D used by the separate talker 1 to be displayed on the respective displays in the terminal devices 12 (that is, the terminal devices 12A, 12B, 12C, 12D, and 12E) of the participants. Similarly, the communication control unit 34 causes the real image 44E (that is, the image 44E not processed by the image processing function) generated by image capture performed by the camera in the terminal device 12E used by the separate talker 2 on the other end of the separate conversation to be displayed on the respective displays in the terminal devices 12 of the participants.

When the separate talker 1 releases the button 50 (that is, in the case where the button 50 is not being pressed), the communication control unit 34 switches the output destination of the microphone used by the separate talker 1 to the separate conversation with the separate talker 2. Similarly, the communication control unit 34 switches the output destination of the microphone used by the separate talker 2 to the separate conversation. The communication control unit 34 also causes the images 44D and 44E processed by the image processing function to be displayed on the respective displays in the terminal devices 12A, 12B, and 12C, and causes the unprocessed images 44D and 44E to be displayed on the respective displays in the terminal devices 12D and 12E.

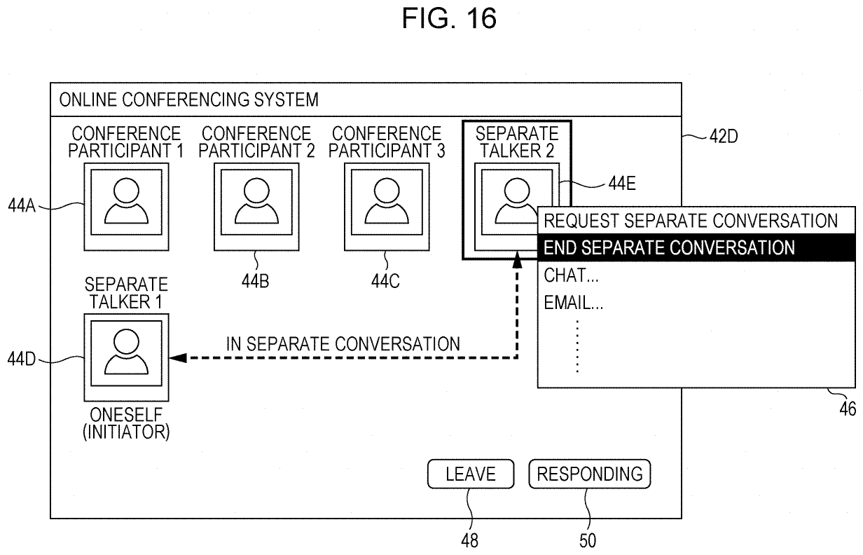

FIG. 16 illustrates the flow of processes when the separate conversation is ended. For example, when ending the separate conversation with the separate talker 2, the separate talker 1 specifies the image 44E of the separate talker 2 to bring up the menu 46, and selects “End separate conversation” from the menu 46. The communication control unit 34 receives the selection, ends the separate conversation between the separate talkers 1 and 2, and reverts the microphone output destination settings, the speaker settings, and the image display settings back to the settings before the separate conversation took place. For example, the communication control unit 34 reverts the settings during the separate conversation illustrated in FIG. 14 back to the settings illustrated in FIG. 11. Note that the separate talker 2 may also end the separate conversation.

During a separate conversation, a conference participant not participating in the separate conversation may also request a separate conversation with a separate talker. In this case, the separate talker receiving the request may end the separate conversation and start a new separate conversation with the requesting conference participant.

Note that the processor 20 of the online conferencing service may also convert the content of the conversation into text and cause the converted text to be displayed on the display in the terminal device 12 of each participant. The conversion may also be performed by the processor 28 in the terminal device 12 of each participant.

The functions of the online conferencing system 10 and the terminal device 12 above are achieved by the cooperative action of hardware and software as an example. For instance, the functions of each device are achieved by causing a processor in each device to load and execute a program stored in a memory of each device. The program is stored in the memory through a recording medium such as a CD or DVD, or alternatively through a communication channel such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to output, in a case where a service is being used in which at least speech is exchanged among a plurality of users such that a conversation takes places among all of the plurality of users, a speech of a separate conversation distinctly from a speech of the conversation taking place among all of the plurality of users to a device of a user who is engaged in the separate conversation with a specific user from among the plurality of users, and output the speech of the conversation taking place among all of the plurality of users without outputting the speech of the separate conversation to a device of a user who is not engaged in the separate conversation.

2. The information processing device according to claim 1, wherein the processor is configured to output, in a case where a speaker used by the user engaged in the separate conversation within the service is a stereo speaker, the speech of the separate conversation and the speech of the conversation taking place among all of the plurality of the users from respectively different channels of the stereo speaker.

3. The information processing device according to claim 1, wherein in a case where a speaker used by the user engaged in the separate conversation within the service is a monaural speaker, the processor is configured to raise a volume of the speech of the separate conversation higher than a volume of the speech of the conversation taking place among all of the plurality of users, and output the speech of the conversation taking place among all of the plurality of the users and the speech of the separate conversation from the monaural speaker.

4. The information processing device according to claim 1, wherein:
respective images of the plurality of users are additionally transmitted and received in the service, and
the processor is configured to process an image of a face of a user engaged in the separate conversation in the service, and cause the processed image to be displayed on a display in a device of a user who is not engaged in the separate conversation.

5. The information processing device according to claim 2, wherein:
respective images of the plurality of users are additionally transmitted and received in the service, and
the processor is configured to process an image of a face of a user engaged in the separate conversation in the service, and cause the processed image to be displayed on a display in a device of a user who is not engaged in the separate conversation.

6. The information processing device according to claim 3, wherein:
respective images of the plurality of users are additionally transmitted and received in the service, and
the processor is configured to process an image of a face of a user engaged in the separate conversation in the service, and cause the processed image to be displayed on a display in a device of a user who is not engaged in the separate conversation.

7. The information processing device according to claim 1, wherein the processor is further configured to:
output the speech of a user engaged in the separate conversation to only a device of another user engaged in the separate conversation with the user engaged in the separate conversation; and
in a case where the user engaged in the separate conversation responds to the conversation taking place among all of the plurality of users, suspend the separate conversation and output the speech of the user engaged in the separate conversation to the devices of all of the plurality of users.

8. The information processing device according to claim 2, wherein the processor is further configured to:
output the speech of a user engaged in the separate conversation to only a device of another user engaged in the separate conversation with the user engaged in the separate conversation; and
in a case where the user engaged in the separate conversation responds to the conversation taking place among all of the plurality of users, suspend the separate conversation and output the speech of the user engaged in the separate conversation to the devices of all of the plurality of users.

9. The information processing device according to claim 3, wherein the processor is further configured to:
output the speech of a user engaged in the separate conversation to only a device of another user engaged in the separate conversation with the user engaged in the separate conversation; and
in a case where the user engaged in the separate conversation responds to the conversation taking place among all of the plurality of users, suspend the separate conversation and output the speech of the user engaged in the separate conversation to the devices of all of the plurality of users.

10. The information processing device according to claim 4, wherein the processor is further configured to:
output the speech of a user engaged in the separate conversation to only a device of another user engaged in the separate conversation with the user engaged in the separate conversation; and
in a case where the user engaged in the separate conversation responds to the conversation taking place among all of the plurality of users, suspend the separate conversation and output the speech of the user engaged in the separate conversation to the devices of all of the plurality of users.

11. The information processing device according to claim 5, wherein the processor is further configured to:
output the speech of a user engaged in the separate conversation to only a device of another user engaged in the separate conversation with the user engaged in the separate conversation; and
in a case where the user engaged in the separate conversation responds to the conversation taking place among all of the plurality of users, suspend the separate conversation and output the speech of the user engaged in the separate conversation to the devices of all of the plurality of users.

12. The information processing device according to claim 6, wherein the processor is further configured to:
output the speech of a user engaged in the separate conversation to only a device of another user engaged in the separate conversation with the user engaged in the separate conversation; and
in a case where the user engaged in the separate conversation responds to the conversation taking place among all of the plurality of users, suspend the separate conversation and output the speech of the user engaged in the separate conversation to the devices of all of the plurality of users.

13. The information processing device according to claim 7, wherein the processor is further configured to:
cause an image for responding to the conversation taking place among all of the plurality of users to be displayed on a display in a device of the user engaged in the separate conversation; and
in a case where the image is being operated by the user engaged in the separate conversation, suspend the separate conversation and output the speech of the user engaged in the separate conversation to the devices of all of the plurality of users.

14. The information processing device according to claim 8, wherein the processor is further configured to:
cause an image for responding to the conversation taking place among all of the plurality of users to be displayed on a display in a device of the user engaged in the separate conversation; and
in a case where the image is being operated by the user engaged in the separate conversation, suspend the separate conversation and output the speech of the user engaged in the separate conversation to the devices of all of the plurality of users.

15. The information processing device according to claim 9, wherein the processor is further configured to:
cause an image for responding to the conversation taking place among all of the plurality of users to be displayed on a display in a device of the user engaged in the separate conversation; and
in a case where the image is being operated by the user engaged in the separate conversation, suspend the separate conversation and output the speech of the user engaged in the separate conversation to the devices of all of the plurality of users.

16. The information processing device according to claim 10, wherein the processor is further configured to:
cause an image for responding to the conversation taking place among all of the plurality of users to be displayed on a display in a device of the user engaged in the separate conversation; and
in a case where the image is being operated by the user engaged in the separate conversation, suspend the separate conversation and output the speech of the user engaged in the separate conversation to the devices of all of the plurality of users.

17. The information processing device according to claim 11, wherein the processor is further configured to:
cause an image for responding to the conversation taking place among all of the plurality of users to be displayed on a display in a device of the user engaged in the separate conversation; and
in a case where the image is being operated by the user engaged in the separate conversation, suspend the separate conversation and output the speech of the user engaged in the separate conversation to the devices of all of the plurality of users.

18. The information processing device according to claim 7, wherein in a case where the user engaged in the separate conversation responds to the conversation taking place among all of the plurality of users, the processor is further configured to cause an unprocessed image of the user engaged in the separate conversation to be displayed on displays of the devices of all of the plurality of users.

19. An information processing method comprising:
outputting, in a case where a service is being used in which at least speech is exchanged among a plurality of users such that a conversation takes places among all of the plurality of users, a speech of a separate conversation distinctly from a speech of the conversation taking place among all of the plurality of users to a device of a user who is engaged in the separate conversation with a specific user from among the plurality of users, and outputting the speech of the conversation taking place among all of the plurality of users without outputting the speech of the separate conversation to a device of a user who is not engaged in the separate conversation.

20. A non-transitory computer readable medium storing a program causing a computer to execute a process comprising:
outputting, in a case where a service is being used in which at least speech is exchanged among a plurality of users such that a conversation takes places among all of the plurality of users, a speech of a separate conversation distinctly from a speech of the conversation taking place among all of the plurality of users to a device of a user who is engaged in the separate conversation with a specific user from among the plurality of users, and outputting the speech of the conversation taking place among all of the plurality of users without outputting the speech of the separate conversation to a device of a user who is not engaged in the separate conversation.
